(19) United States
(12) Patent Application Publication
(10) Pub. No.: US 2026/0078813 A1
(43) Pub. Date: Mar. 19, 2026

(54) E-BEAMS WITH DRIVE SHAFTS OFFSET FROM ROTOR SHAFT

(71) Applicant: FCA US LLC, Auburn Hills, MI (US)

(72) Inventor: Gregory Mordukhovich, Auburn Hills, MI (US)

(21) Appl. No.: 18/976,975

(22) Filed: Dec. 11, 2024

Related U.S. Application Data
(60) Provisional application No. 63/696,046, filed on Sep. 18, 2024.

(51) Int. Cl. F16H 37/08; B60K 1/00; B60K 17/04

(52) U.S. Cl. CPC F16H 37/0813; B60K 1/00; B60K 17/046; B60K 2001/001; B60K 2007/0092; B60K 17/165; B60K 17/344

(57) ABSTRACT

An electrified powertrain that generates and transfers drive torque to a driveline of an electrified vehicle includes an electric drive module, a pinion that drives a drive gear, and a differential. The electric drive module comprises a housing and an electric motor having a rotor that rotates a rotor shaft relative to a stator that is fixed to the housing. The pinion gear is driven by the rotor shaft. The differential is driven by the drive gear and includes first and second side gears. The first side gear drives a first output shaft that drives a first drive wheel. The second side gear drives a second output shaft that drives a second drive wheel. The first and second output shafts are parallel and offset relative to the rotor shaft.

### CROSS-REFERENCE TO RELATED APPLICATIONS

This application claims priority to U.S. Provisional Patent Application No. 63/696,046 , filed Sep. 18, 2024. The disclosure of the above application is incorporated herein by reference in its entirety.

### FIELD

The present application generally relates to electrified vehicles and, more particularly, to a coaxial e-beam.

### BACKGROUND

An electrified vehicle (hybrid electric, plug-in hybrid electric, range-extended electric, battery electric, etc.) includes at least one battery system and at least one electronic drive module having at least one electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The electric drive gearbox assembly can be configured in many ways to achieve various gear ratios for accessing during specific drive conditions. In some examples it can be challenging to provide an electric drive gearbox assembly that includes desired gear ratios while satisfying packaging constraints and allowing for reduced cost gears. Accordingly, while such electronic drive modules do work well for their intended purpose, there is a desire for improvement in the relevant art.

### SUMMARY

An electrified powertrain that generates and transfers drive torque to a driveline of an electrified vehicle includes an electric drive module, a pinion that drives a drive gear, and a differential. The electric drive module comprises a housing and an electric motor having a rotor that rotates a rotor shaft relative to a stator that is fixed to the housing. The pinion gear is driven by the rotor shaft. The differential is driven by the drive gear and includes first and second side gears. The first side gear drives a first output shaft that drives a first drive wheel. The second side gear drives a second output shaft that drives a second drive wheel. The first and second output shafts are parallel and offset relative to the rotor shaft.

In other examples, the electrified powertrain further includes a first final drive planetary gear set that is driven by the first output shaft and that drives the first drive wheel.

In additional examples, the electrified powertrain further includes a second final drive planetary gear set that is driven by the second output shaft and that drives the second drive wheel.

In some implementations, the drive gear is fixed for rotation with the differential.

In examples, the pinion and drive gear provide a first gear ratio reduction.

In implementations, the first final drive planetary gear set provides a second gear ratio reduction, wherein a total gear reduction from the rotor shaft to the first drive wheel is provided by a sum of the first and second gear ratio reductions.

In other implementations, the second final drive planetary gear set provides a second gear ratio reduction, wherein a total gear reduction from the rotor shaft to the second drive wheel is provided by a sum of the first and second gear ratio reductions.

In other examples, the first gear ratio reduction is between 4 and 4.5.

### BRIEF DESCRIPTION OF THE DRAWINGS

FIG. 1 is a functional block diagram of an electrified vehicle having an electronic drive module (EDM) according to various principles of the present application;

FIG. 2 is a schematic illustration of an EDM having a stepped planetary and fixed ring gear constructed according to various examples of the present disclosure;

FIG. 3 is a schematic illustration of an EDM having a stepped planetary, fixed ring gear and clutch damping constructed according to various examples of the present disclosure;

FIG. 4 is a schematic illustration of an EDM having a stepped planetary, fixed second sun gear and no ring gear constructed according to various examples of the present disclosure;

FIG. 5 is a schematic illustration of an EDM having a stepped planetary, final drives and a fixed ring gear constructed according to various examples of the present disclosure;

FIG. 6 is a schematic illustration of an EDM having a stepped planetary, final drives, fixed ring gear and a clutch constructed according to various examples of the present disclosure;

FIG. 7 is a schematic illustration of an EDM having a stepped planetary, final drives and a fixed second ring gear constructed according to various examples of the present disclosure;

FIG. 8 is a schematic illustration of an EDM having a simple planetary, final drives and a fixed ring gear constructed according to various examples of the present disclosure;

FIG. 9 is a schematic illustration of an EDM having a simple planetary, final drives, fixed ring gear and a clutch constructed according to various examples of the present disclosure;

FIG. 10 is a schematic illustration of an EDM having a simple planetary, final drives, and a fixed ring gear constructed according to various examples of the present disclosure;

FIG. 11 is a schematic illustration of an EDM having a simple planetary, final drives, and a ring gear fixed to a stator constructed according to various examples of the present disclosure;

FIG. 12 is a schematic illustration of an EDM having a simple planetary, final drives, a ring gear fixed to a stator, and a clutch constructed according to various examples of the present disclosure;

FIG. 13 is a schematic illustration of an EDM having a simple planetary, final drives, and a fixed ring gear constructed according to various examples of the present disclosure; and

FIG. 14 is a schematic illustration of an offset EDM having a differential with two final drive planetary assemblies constructed according to various examples of the present disclosure.

### DESCRIPTION

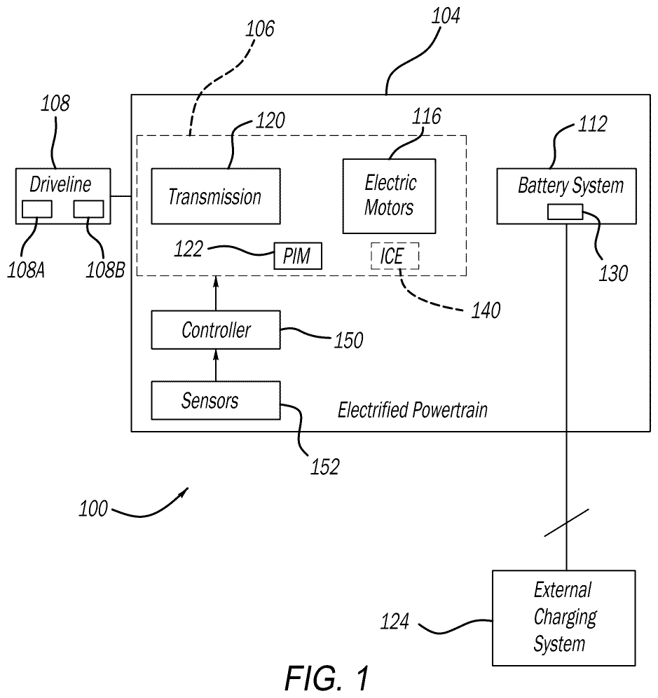

Referring now to FIG. 1, a functional block diagram of an example electrified vehicle 100 (also referred to herein as “vehicle 100”) according to the principles of the present application is illustrated. The vehicle 100 includes an electrified powertrain 104 having an electric drive module (EDM) 106 configured to generate and transfer drive torque to a driveline 108 for vehicle propulsion. The EDM 106 generally includes an electric machine or motor 116 (e.g., one or more electric traction motors), an electric drive gearbox assembly or transmission, collectively identified at 120, and power electronics including a power inverter module (PIM) 122.

The electric motor 116 is selectively connectable via the PIM 124 to a high voltage battery system 112 for powering the electric motor 116. The battery system 112 is selectively connectable (e.g., by the driver) to an external charging system 124 (also referred to herein as “charger 124”) for charging of the battery system 112. The battery system 112 includes at least one battery pack assembly 130. In some examples, described herein, the electrified powertrain 104 can be a hybrid powertrain that additionally includes an internal combustion engine 140. A controller 150 can provide various inputs to the EDM 106, based on signals received from sensors 152 to operate the EDM in various modes based on operating conditions as described herein.

Among the biggest concerns when configuring an EDM having a coaxial powerflow includes pitch line velocity. The pitch line velocity is a function of the size of the sun gear. The size of the output shaft defines the size of the sun gear. When the size increases, so does the pitch line velocity which can cause issues with NVH. Further, the size of the ring gear is critical. As the ring gear is fixed to the housing, the ring gear can contribute negatively to NVH.

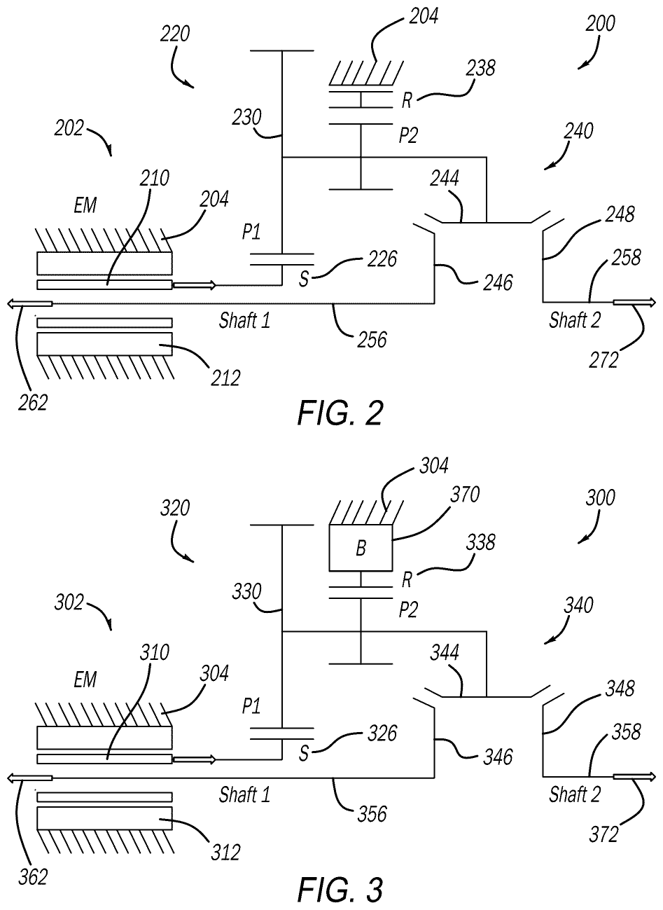

FIG. 2 illustrates an EDM 200. The EDM 200 includes an electric machine 202 and a housing 204. The electric machine 202 includes a rotor 210 and stator 212. A stepped planetary gear set 220 includes a sun gear 226, a carrier 230, and a ring gear 238. A differential 240 is disposed in the EDM 200 and can include a housing 244 a first side gear 246 and a second side gear 248. The first side gear 246 can drive a first output shaft 256 that ultimately drives a first drive wheel 262. The first output shaft 256 extends through the electric machine 202. The second side gear 248 can drive a second output shaft 258 that ultimately drives a second drive wheel 272.

FIG. 3 illustrates an EDM 300. The EDM 300 includes an electric machine 302 and a housing 304. The electric machine 302 includes a rotor 310 and stator 312. A stepped planetary gear set 320 includes a sun gear 326, a carrier 330, and a ring gear 338. A differential 340 is disposed in the EDM 300 and can include a housing 344 a first side gear 346 and a second side gear 348. The first side gear 346 can drive a first output shaft 356 that ultimately drives a first drive wheel 362. The first output shaft 356 extends through the electric machine 302. The second side gear 348 can drive a second output shaft 358 that ultimately drives a second drive wheel 372. A clutch 370, acting as a damper, is located between the ring gear 338 and the housing 304. The use of the damper allows the quality of the ring gear 338 to be reduced. The clutch 370 can be used as a disconnect.

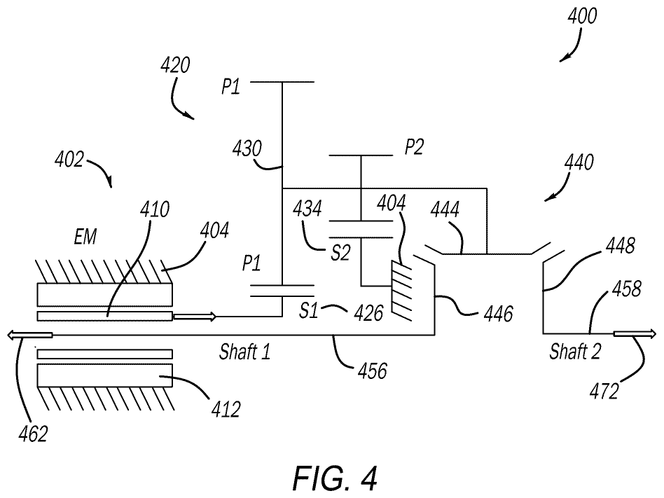

FIG. 4 illustrates an EDM 400. The EDM 400 includes an electric machine 402 and a housing 404. The electric machine 402 includes a rotor 410 and stator 412. A stepped planetary gear set 420 includes a first sun gear 426, a carrier 430, and a second sun gear 434. The second sun gear 434 is fixed to the housing 404. A differential 440 is disposed in the EDM 400 and can include a housing 444 a first side gear 446 and a second side gear 448. The first side gear 446 can drive a first output shaft 456 that ultimately drives a first drive wheel 462. The first output shaft 456 extends through the electric machine 402. The second side gear 448 can drive a second output shaft 458 that ultimately drives a second drive wheel 472.

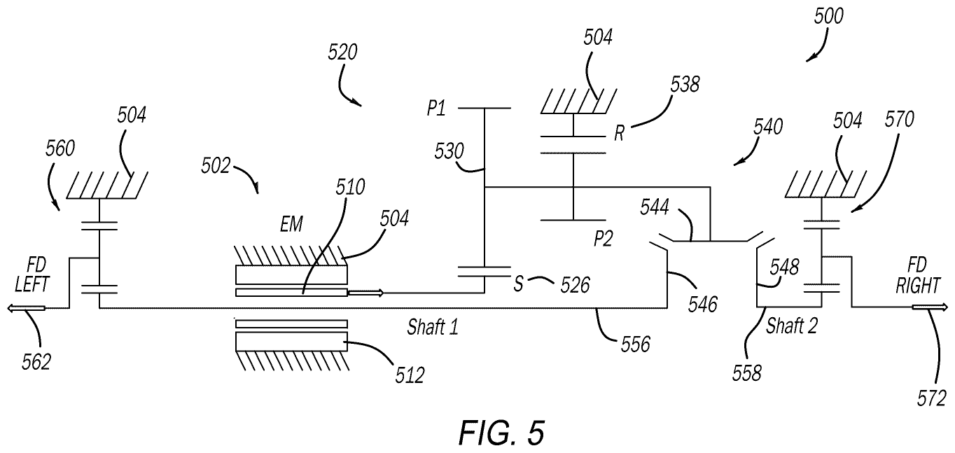

FIG. 5 illustrates an EDM 500. The EDM 500 includes an electric machine 502 and a housing 504. The electric machine 502 includes a rotor 510 and stator 512. A stepped planetary gear set 520 includes a sun gear 526, a carrier 530, and a ring gear 538. A differential 540 can be disposed in the EDM 500 and include a housing 544 a first side gear 546 and a second side gear 548. The first side gear 546 can drive a first output shaft 556. The first output shaft 556 extends through the electric machine 502. The first output shaft 556 drives a first final drive planetary gear set 560 that connects to a first drive wheel 562. The second side gear 548 can drive a second output shaft 558. The second output shaft 558 drives a second final drive planetary gear set 570 that connects to a second drive wheel 572.

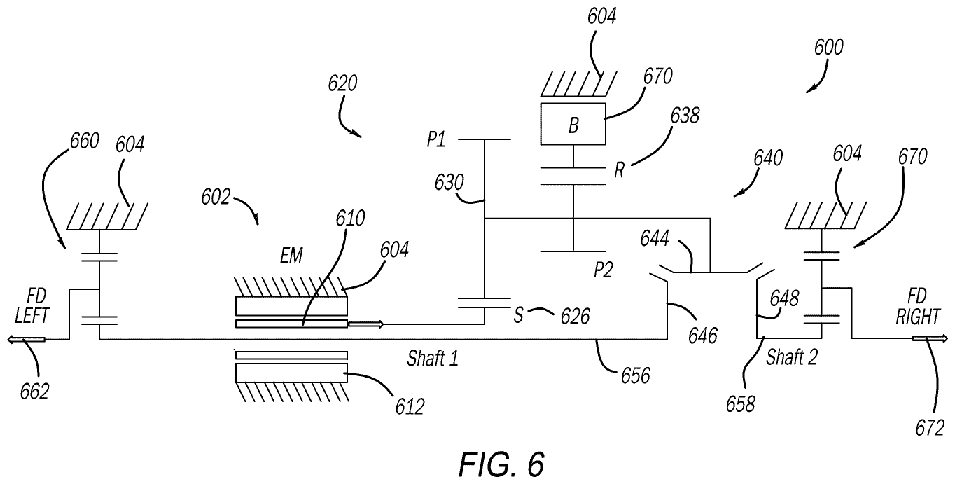

FIG. 6 illustrates an EDM 600. The EDM 600 includes an electric machine 602 and a housing 604. The electric machine 602 includes a rotor 610 and stator 612. A stepped planetary gear set 620 includes a sun gear 626, a carrier 630, and a ring gear 638. A differential 640 is disposed in the EDM 600 and can include a housing 644 a first side gear 646 and a second side gear 648. The first side gear 646 can drive a first output shaft 656. The first output shaft 656 extends through the electric machine 602. The first output shaft 656 drives a first final drive planetary gear set 660 that connects to a first drive wheel 662. The second side gear 648 can drive a second output shaft 658. The second output shaft 658 drives a second final drive planetary gear set 670 that connects to a second drive wheel 672. A clutch 670, acting as a damper, is located between the ring gear 638 and the housing 604. The use of the damper allows the quality of the ring gear 638 to be reduced. The clutch 670 can be used as a disconnect.

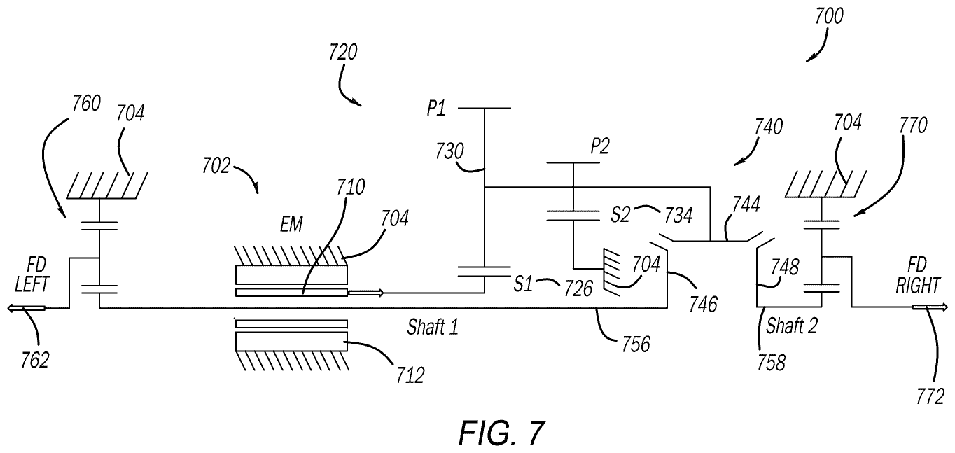

FIG. 7 illustrates an EDM 700. The EDM 700 includes an electric machine 702 and a housing 704. The electric machine 702 includes a rotor 710 and stator 712. A stepped planetary gear set 720 includes a first sun gear 726, a carrier 730, and a second sun gear 734. The second sun gear 734 is fixed to the housing 704. A differential 740 is disposed in the EDM 700 and can include a housing 744 a first side gear 746 and a second side gear 748. The first side gear 746 can drive a first output shaft 756. The first output shaft 756 extends through the electric machine 702. The first output shaft 756 drives a first final drive planetary gear set 760 that connects to a first drive wheel 762. The second side gear 748 can drive a second output shaft 758. The second output shaft 758 drives a second final drive planetary gear set 770 that connects to a second drive wheel 772.

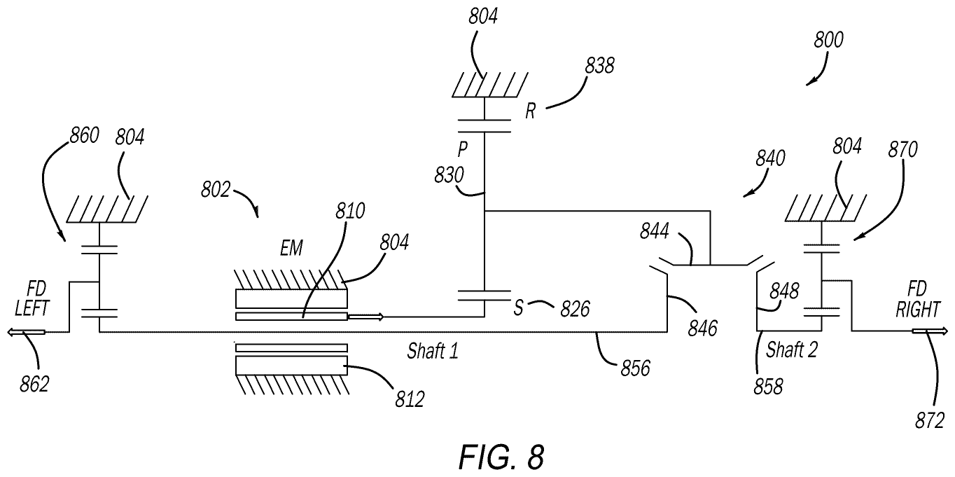

FIG. 8 illustrates an EDM 800. The EDM 800 includes an electric machine 802 and a housing 804. The electric machine 802 includes a rotor 810 and stator 812. A planetary gear set 820 includes a sun gear 826, a carrier 830, and a ring gear 838. The ring gear 838 is fixed to the housing 804. A differential 840 is disposed in the EDM 800 and can include a housing 844 a first side gear 846 and a second side gear 848. The first side gear 846 can drive a first output shaft 856. The first output shaft 856 extends through the electric machine 802. The first output shaft 856 drives a first final drive planetary gear set 860 that connects to a first drive wheel 862. The second side gear 848 can drive a second output shaft 858. The second output shaft 858 drives a second final drive planetary gear set 870 that connects to a second drive wheel 872.

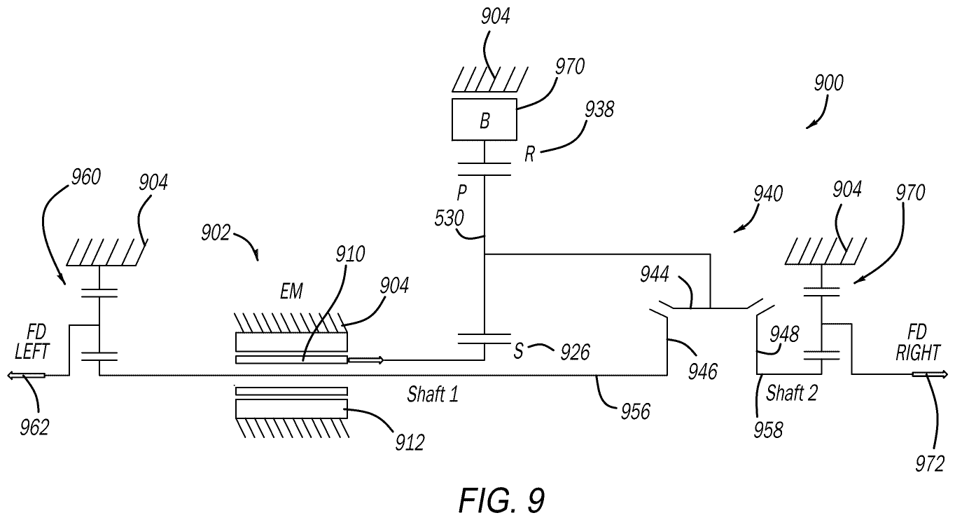

FIG. 9 illustrates an EDM 900. The EDM 900 includes an electric machine 902 and a housing 904. The electric machine 902 includes a rotor 910 and stator 912. A planetary gear set 920 includes a sun gear 926, a carrier 930, and a ring gear 938. A clutch 970, acting as a damper, is located between the ring gear 938 and the housing 904. The use of the damper allows the quality of the ring gear 938 to be reduced. The clutch 970 can be used as a disconnect. A differential 940 is disposed in the EDM 900 and can include a housing 944 a first side gear 946 and a second side gear 948. The first side gear 946 can drive a first output shaft 956. The first output shaft 956 extends through the electric machine 902. The first output shaft 956 drives a first final drive planetary gear set 960 that connects to a first drive wheel 962. The second side gear 948 can drive a second output shaft 958. The second output shaft 958 drives a second final drive planetary gear set 970 that connects to a second drive wheel 972.

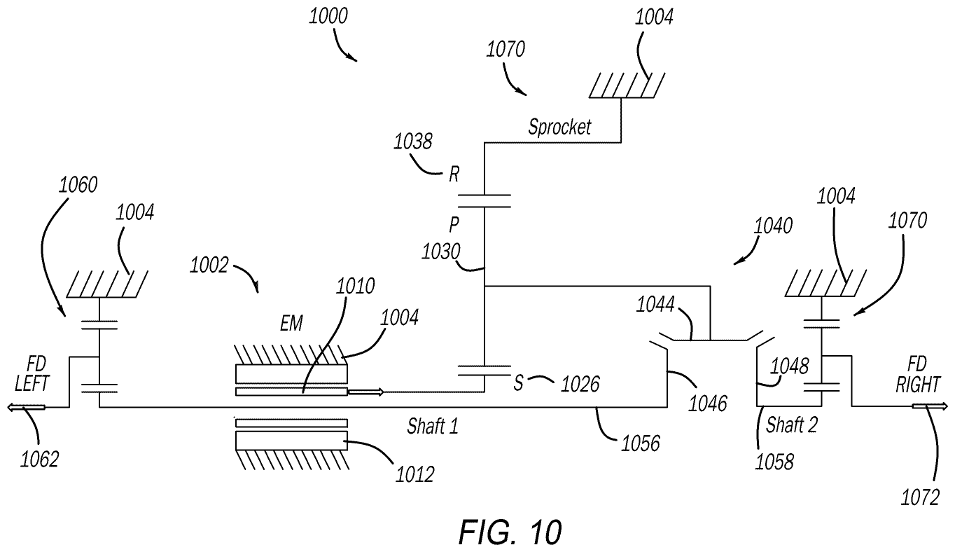

FIG. 10 illustrates an EDM 1000. The EDM 1000 includes an electric machine 1002 and a housing 1004. The electric machine 1002 includes a rotor 1010 and stator 1012. A planetary gear set 1020 includes a sun gear 1026, a carrier 1030, and a ring gear 1038. A sprocket 1070, is located between the ring gear 1038 and the housing 1004. The use of the sprocket 1070 allows the quality of the ring gear 1038 to be reduced. The clutch 1070 can be used as a disconnect. A differential 1040 is disposed in the EDM 1000 and can include a housing 1044 a first side gear 1046 and a second side gear 1048. The first side gear 1046 can drive a first output shaft 1056. The first output shaft 1056 extends through the electric machine 1002. The first output shaft 1056 drives a first final drive planetary gear set 1060 that connects to a first drive wheel 1062. The second side gear 1048 can drive a second output shaft 1056. The second output shaft 1058 drives a second final drive planetary gear set 1070 that connects to a second drive wheel 1072.

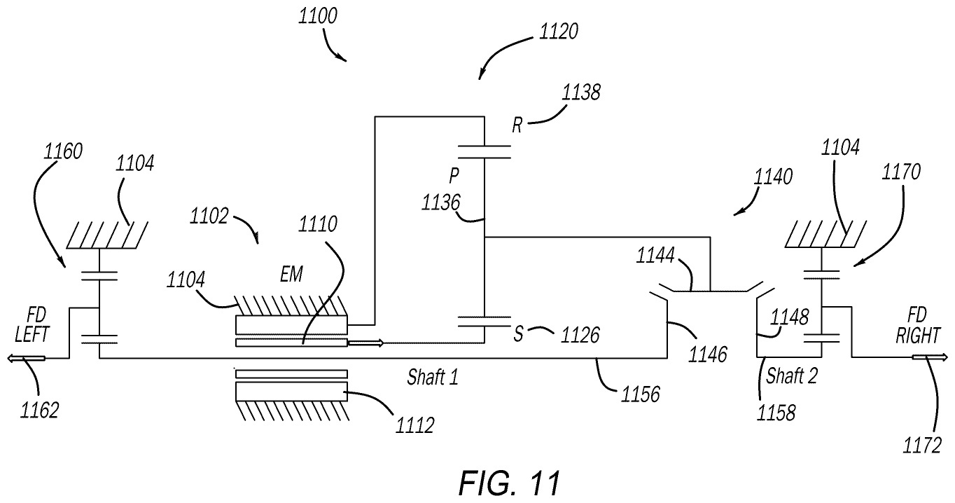

FIG. 11 illustrates an EDM 1100. The EDM 1100 includes an electric machine 1102 and a housing 1104. The electric machine 1102 includes a rotor 1110 and stator 1112. The stator 1112 is fixed to the housing 1104. The rotor 1110 is configured to rotate relative to the stator 1112. A planetary gear set 1120 includes a sun gear 1126, a carrier 1130, and a ring gear 1138. The ring gear 1138 is fixed to the stator 1112. A differential 1140 is disposed in the EDM 1100 and can include a housing 1144 a first side gear 1146 and a second side gear 1148. The first side gear 1146 can drive a first output shaft 1156. The first output shaft 1156 extends through the electric machine 1102. The first output shaft 1156 drives a first final drive planetary gear set 1160 that connects to a first drive wheel 1162. The second side gear 1148 can drive a second output shaft 1158. The second output shaft 1158 drives a second final drive planetary gear set 1170 that connects to a second drive wheel 1172. In examples, the vibration from stator 1112 can be used as a reaction member and absorbed by the gear configuration of the EDM 1100. A lower quality ring gear 1138 that does not require high cost finishing can be incorporated in the EDM 1100.

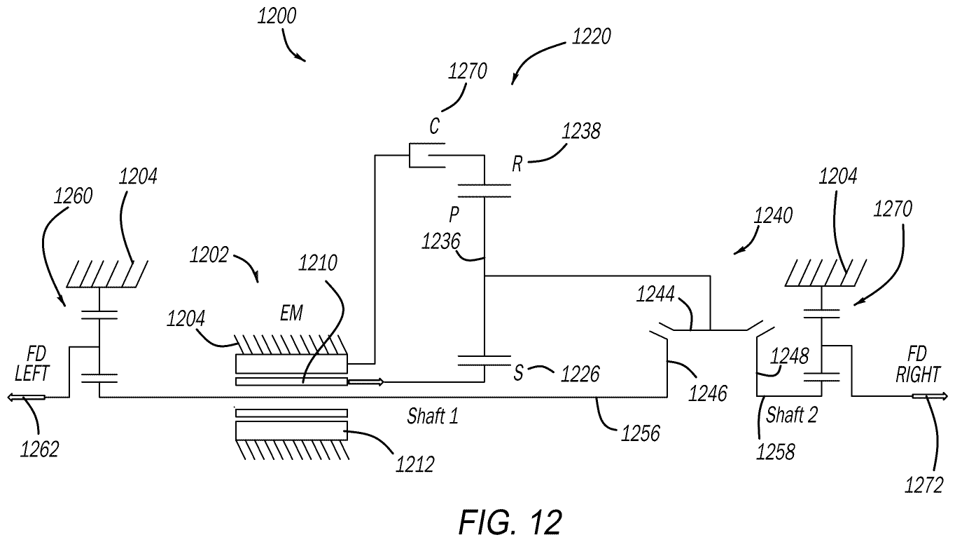

FIG. 12 illustrates an EDM 1200. The EDM 1200 includes an electric machine 1202 and a housing 1204. The electric machine 1202 includes a rotor 1210 and stator 1212. The stator 1212 is fixed to the housing 1204. The rotor 1210 is configured to rotate relative to the stator 1212. A planetary gear set 1220 includes a sun gear 1226, a carrier 1230, and a ring gear 1238. The ring gear 1238 is coupled to the stator 1212 through a clutch 1270. A differential 1240 is disposed in the EDM and can include a housing 1244 a first side gear 1246 and a second side gear 1248. The first side gear 1246 can drive a first output shaft 1256. The first output shaft 1256 extends through the electric machine 1202. The first output shaft 1256 drives a first final drive planetary gear set 1260 that connects to a first drive wheel 1262. The second side gear 1248 can drive a second output shaft 1258. The second output shaft 1258 drives a second final drive planetary gear set 1270 that connects to a second drive wheel 1272. In examples, the vibration from stator 1212 can be used as a reaction member and absorbed by the gear configuration of the EDM 1200. A lower quality ring gear 1238 that does not require high cost finishing can be incorporated in the EDM 1200. In examples, the clutch 1270 provides a disconnect between the drive wheels 1262 and 1272 and the motor 1202. In implementations, the clutch 1270 can be normally closed.

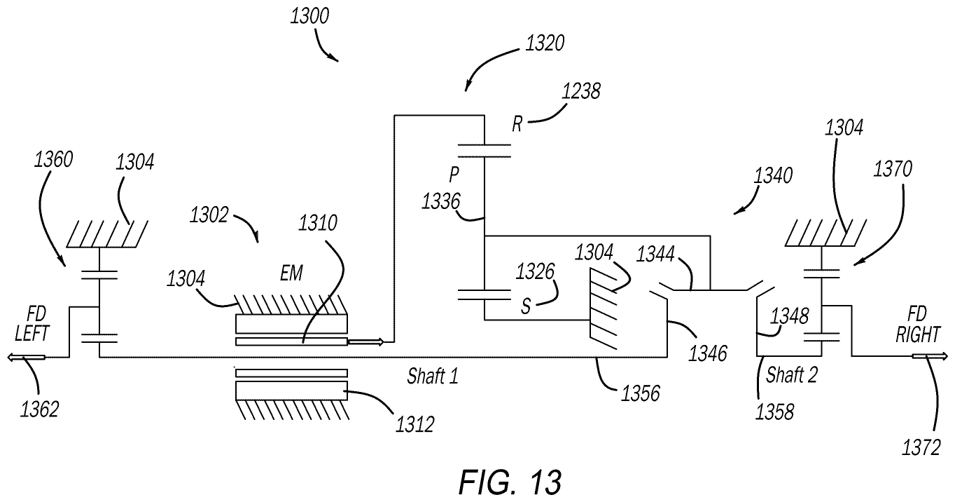

FIG. 13 illustrates an EDM 1300. The EDM 1300 includes an electric machine 1302 and a housing 1304. The electric machine 1302 includes a rotor 1310 and stator 1312. The stator 1312 is fixed to the housing 1304. The rotor 1310 is configured to rotate relative to the stator 1312. A planetary gear set 1320 includes a sun gear 1326, a carrier 1330, and a ring gear 1338. The ring gear 1338 is coupled to the rotor 1310. The sun gear 1326 is fixed to the housing 1304. A differential 1340 is disposed in the EDM 1300 and can include a housing 1344 a first side gear 1346 and a second side gear 1348. The first side gear 1346 can drive a first output shaft 1356. The first output shaft 1356 extends through the electric machine 1302. The first output shaft 1356 drives a first final drive planetary gear set 1360 that connects to a first drive wheel 1362. The second side gear 1348 can drive a second output shaft 1358. The second output shaft 1358 drives a second final drive planetary gear set 1370 that connects to a second drive wheel 1372. In examples, the vibration from stator 1312 can be used as a reaction member and absorbed by the gear configuration of the EDM 1300. A lower quality ring gear 1338 that does not require high cost finishing can be incorporated in the EDM 1300.

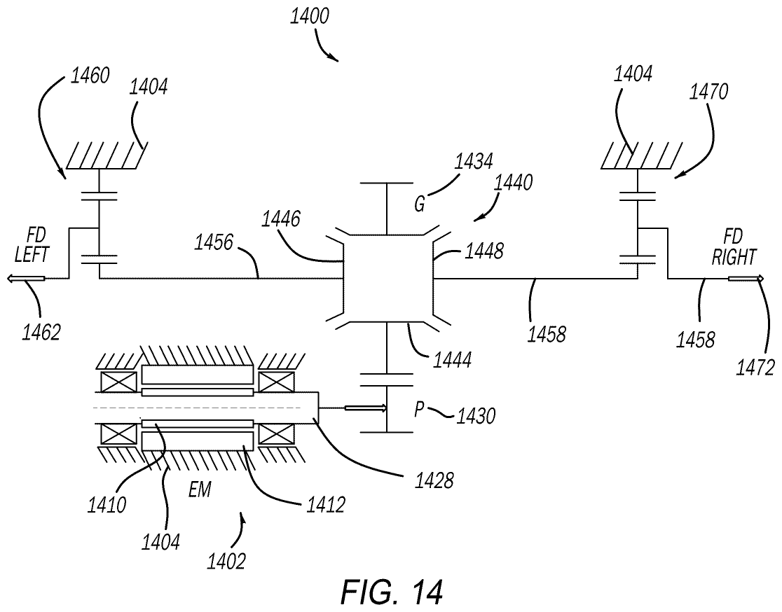

FIG. 14 illustrates an EDM 1400. The EDM 1400 is not coaxial as the above described EDM's. Instead, the EDM 1400 is offset. The EDM 1400 includes an electric motor or machine 1402 and a housing 1404. The electric machine 1402 includes a rotor 1410 and stator 1412. The rotor 1410 drives a rotor output shaft 1428 that rotates a pinion gear 1430. The pinion gear 1430 is engaged to a drive gear G 1434. The drive gear G 1434 is attached to a differential 1440. The differential 1440 can include a housing 1444 a first side gear 1446 and a second side gear 1448. The first side gear 1446 can drive a first output shaft 1456. The first output shaft 1456 drives a first final drive planetary gear set 1460 that connects to a first drive wheel 1462. The second side gear 1448 can drive a second output shaft 1458. The second output shaft 1458 drives a second final drive planetary gear set 1470 that connects to a second drive wheel 1472. Notably, the smallest input pinion 1430 is not limited by the output shaft 1428 which reduces pitch line velocity (reduced NVH and scuffing risk). As such, the input pinion 1430 can be as small as necessary. Any ratio is possible from the pinion gear 1430 to the gear 1434, such as for example 4 or 4.5. The final drive planetary gearsets 1460, 1470 can be configured as needed to achieve a final combined gear reduction from the 1428 to the drive wheels 1462, 1472. The pinion gear 1430 and the drive gear 1434 provide a first gear ratio reduction. The first final drive planetary gear set 1462 (and the second final drive planetary gear set 1470) provides a second gear ratio reduction. A total gear reduction from the rotor shaft 1428 to the first drive wheel 1462 (and the second drive wheel 1472) is provided by a sum of the first and second gear ratio reductions. The first and second output shafts 1456 and 1458 are parallel and offset relative to the rotor shaft 1428.

The size of the differential 1440 can be reduced as no output shaft is extending therethrough. The same power rating is achieved with increased speed which can lead to a reduction in permanent magnet volume and a cost reduction. The overall radial packaging for the EDM 1400 may be equal to or smaller than the coaxial architecture without NVH, scuffing risks, and hard finishing of the planetary internal gears with a smaller (weight and cost) differential. In the EDM 1400, the half shafts now do not pass through the rotor (as described above with the EDM's in FIGS. 2-13). Moreover, the EDM 1400 can be easily manufactured and cost effective.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

1. An electrified powertrain that generates and transfers drive torque to a driveline of an electrified vehicle, the electrified powertrain comprising:
an electric drive module comprising:
a housing; and
an electric motor having a rotor that rotates a rotor shaft relative to a stator that is fixed to the housing;
a pinion gear that is driven by the rotor shaft and that drives a drive gear;
a differential that is driven by the drive gear, the differential comprising:
a first side gear that drives a first output shaft that drives a first drive wheel, the first side gear rotating along a common axis as the first drive wheel;
a second side gear that drives a second output shaft that drives a second drive wheel, the second side gear rotating along the common axis;
a first final drive planetary gear set that is driven by the first output shaft and that drives the first drive wheel;
a second final drive planetary gear set that is driven by the second output shaft and that drives the second drive wheel; and
wherein the first and second output shafts are parallel and offset relative to the rotor shaft, the rotor shaft being offset relative to the common axis and wherein the first and second output shafts and final drive planetary gear sets are disposed within the housing.

2-4. (canceled)

5. The electrified powertrain of claim 1, wherein the drive gear is fixed for rotation with the differential.

6. The electrified powertrain of claim 1, wherein the pinion and drive gear provide a first gear ratio reduction.

7. The electrified powertrain of claim 6, wherein the first final drive planetary gear set provides a second gear ratio reduction, wherein a total gear reduction from the rotor shaft to the first drive wheel is provided by a sum of the first and second gear ratio reductions.

8. The electrified powertrain of claim 6, wherein the second final drive planetary gear set provides a second gear ratio reduction, wherein a total gear reduction from the rotor shaft to the second drive wheel is provided by a sum of the first and second gear ratio reductions.

9. The electrified powertrain of claim 6, wherein the first gear ratio reduction is between 4 and 4.5.

10. An electrified powertrain that generates and transfers drive torque to a driveline of an electrified vehicle, the electrified powertrain comprising:
an electric drive module comprising:
a housing; and
an electric motor having a rotor that rotates a rotor shaft relative to a stator that is fixed to the housing;
a pinion gear that is driven by the rotor shaft and that drives a drive gear;
a differential that is driven by the drive gear, the differential comprising:
a first side gear that drives a first output shaft that is coaxially arranged relative to and drives a first drive wheel;
a second side gear that drives a second output shaft that is coaxially arranged relative to and drives a second drive wheel; and
wherein the first and second output shafts are parallel and offset relative to the rotor shaft, wherein the rotor shaft is offset relative to a respective rotational axis of the first and second drive wheels;
a first final drive planetary gear set that is directly driven by the first output shaft and that drives the first drive wheel such that the first output shaft and the first drive wheel are laterally displaced exclusively by the first final drive planetary gear set; and
a second final drive planetary gear set that is directly driven by the second output shaft and that drives the second drive wheel such that the first output shaft and the second drive wheel are laterally displaced exclusively by the first final drive planetary gear set, wherein the first and second output shafts and final drive planetary gear sets are disposed within the housing.
